(19) United States
(12) Patent Application Publication
(10) Pub. No.: US 2010/0121523 A1
(43) Pub. Date: May 13, 2010

(54) Mobile Wireless Local Area Network

(76) Inventors: Alan N. Willson, Pasadena, CA (US); Arthur Torosyan, La Crescenta, CA (US)

Correspondence Address: DENIS KHOO, 9729 CAMINO REAL, ARCADIA, CA, 91007, US

(21) Appl. No.: 12/636,665

(22) Filed: Dec. 11, 2009

Related U.S. Application Data
(63) Continuation of application No. 10/176,164, filed on Jun. 19, 2002, now abandoned.
(60) Provisional application No. 60/299,312, filed on Jun. 19, 2001.

(51) Int. Cl. G06F 19/00; G06F 15/16

(52) U.S. Cl. 701/33; 709/217

(57) ABSTRACT

A mobile wireless local area communications network includes a pair of relatively movable nodes, such as a vehicle and a house, which are movable into and out of a defined and limited area of communications relative to the fixed node. Each node has a computer and human interface capabilities to enable transfer of data between the nodes. Each has the ability to automatically connect/disconnect the nodes when the movable node moves into/out of the area of communications. The system causes performance of a function extrinsic to the communication itself as a result of the initiation or the cessation of the communication, even after the nodes have been disconnected.

This application is a continuation of U.S. application Ser. No. 10/176,164 filed on Jun. 19, 2002, which, in turn, claims the benefit of and priority of U.S. Provisional Patent Application Ser. No. 60/299,312, filed on Jun. 19, 2001. The entire contents of Ser. No. 10/176,164 and Ser. No. 60/299,312 are incorporated herein by reference.

### BACKGROUND OF THE INVENTION

1. Field of the Invention

This invention generally relates to mobile communications and, more specifically, to a mobile communications network for communicating information between nodes in a limited-range communications area to effect extrinsic actions.

2. Description of Related Art

In today's fast-paced age, electronic conveniences are rapidly being developed and implemented to simplify and automate everyday chores. Examples are the use of cell phones, which eliminates the necessity of locating and using a fixed land-line phone. Also, the internet has simplified the acquisition of information, which is now available world-wide, anywhere 24/7. Local area networks (LANs) are commonly used in offices to interconnect computers and peripherals for use by many people. In homes, LANs are used for similar communication and for transferring data, including music, downloaded from the internet or read from compact disks, DVDs, or other storage media, between computers and a music system.

Recently, wireless LANS have been developed for use in airports, hotels and other limited areas to enable patrons to log on to the internet. Also, it is known from U.S. Pat. No. 6,246,883 to provide a mobile base station that periodically travels throughout a geographical area, broadcasting information to multiple users in different broadcast areas via a wireless LAN.

There is currently no system which fully exploits the versatility and commercial possibilities of wireless LANs to provide even more convenience, simplification and efficiency to life by automating everyday chores.

### BRIEF SUMMARY OF THE INVENTION

It is therefore and object of this invention to provide a system using a wireless mobile LAN to provide even more convenience, simplification and efficiency to life by automating everyday chores.

In one aspect, this invention features a wireless network that contains one or more mobile nodes, each of which is capable of moving to various distinct (i.e. defined and limited) geographical locations where, until moving again, it automatically becomes a part of a fixed wireless local area network for communication with fixed nodes. Each mobile node has, in addition to its wireless communications capability, computer and human interface capabilities, and various equipment interface capabilities, which enable the automatic performance of useful functions extrinsic to the communication itself, even after the mobile node is disconnected from a fixed node. In one form, the mobile node transmits an identification code and an instruction code which effect performance of some action by the fixed node extrinsic to the communication itself.

In another aspect, this invention features a music playing system that enables identification of a listener to the system, who can then instruct the system to compile a personal “don't play” list of identified music pieces and types of music pieces. This prevents the identified music pieces and types of music pieces from being played when the listener is identified to the system. Multiple listeners and “don't play” lists can be accommodated simultaneously.

### BRIEF DESCRIPTION OF THE DRAWINGS

FIG. 1 is a diagrammatic illustration of the components of a system according to this invention;

FIG. 2 is a depiction of a computer screen showing File-N-Sync Plus settings for a system according to this invention;

FIG. 3 is a flow diagram of a File-N-Sync software program for the system of this invention; and

FIG. 4 is a flow diagram of the automatic transmission of music files between nodes.

### DETAILED DESCRIPTION OF A PREFERRED EMBODIMENT

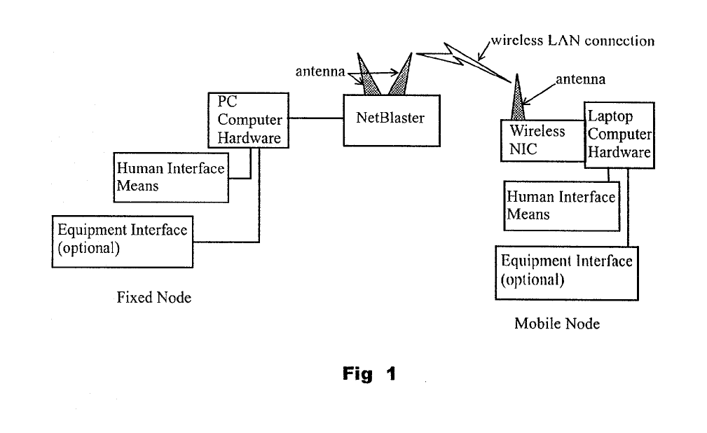

This invention relates to a wireless network that contains both mobile and fixed, or stationary, nodes. The network contains one or more movable or mobile nodes that are capable of moving to various distinct geographical locations where, until moving again, they temporarily become part of a fixed wireless local area network. As shown in FIG. 1, the mobile nodes have, in addition to their wireless communications capability, computer and human interface capabilities, and various equipment interface capabilities, that permit them to perform useful functions, extrinsic to the communication itself, even while the mobile node is disconnected from the other nodes. Specific actions are automatically initiated by the connection and disconnection of a mobile node from the fixed nodes.

One example of a mobile node incorporated in our invention, which we term a Mobile Wireless Local Area Network (MWLAN), is a computer-controlled entertainment/information transfer system that is mounted in an automobile, or other vehicle, and has an antenna that permits it to automatically establish wireless communication with a fixed node, located in a house, or other stationary location, whenever the vehicle is in sufficiently close physical proximity to the house. When, for example, the vehicle is parked in the driveway or garage of a house, both the mobile and fixed nodes establish a wireless LAN connection. Once the LAN connection is established, the contents of the data storage unit of the vehicle's node can be interrogated and modified by transmissions between the nodes.

Examples of applications supported by the interrogation capabilities are the automatic transmission of vehicle diagnostic information to a house where, among other actions, the house node can convey vehicle-status information to the owner—e.g., “low on gas-allow time to buy gas on next trip,” “recent gas mileage is low; perhaps time for a tune-up,” “time for an oil change,” “left-front tire pressure is low—allow time on next trip to fill with air,” etc.

Examples of applications supported by transmissions from the house are the automatic transmission of music files and/or play lists and other music play-control and information files from the house computer's data storage unit to the data storage unit in the vehicle. Such transmissions can be performed automatically by software that interrogates the house computer's music files and the music files on the vehicle computer. After comparing the two sets of files, any files not contained at one node can be automatically transferred to the other. This compare and transfer operation can be initiated automatically upon the establishment of a wireless connection between the vehicle and the house. It can also occur automatically upon the creation or modification of relevant files at any node in the MWLAN, or at specific pre-selected times.

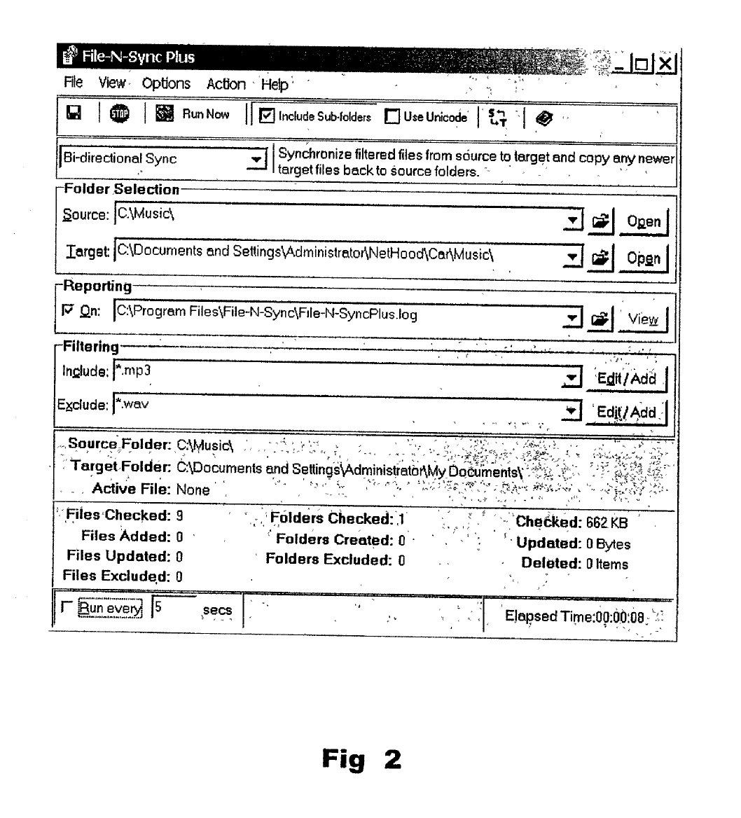

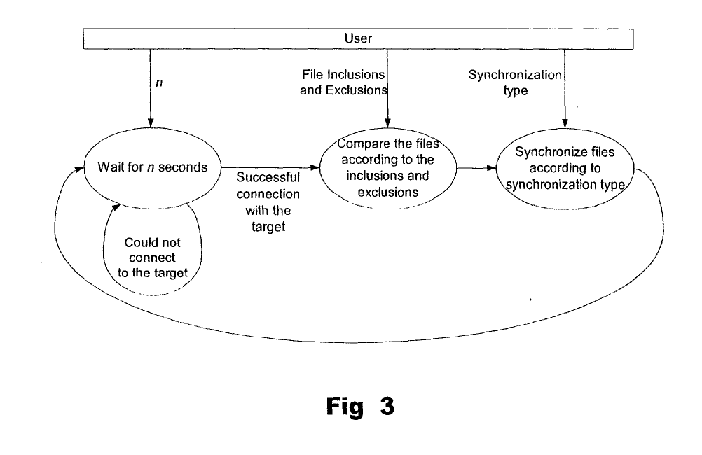

Following is an example for accomplishing the automatic file transfer between the house computer's data storage unit and the data storage unit in the vehicle. The computer at home can run a software program similar to one called File-N-Synch Plus written by Peer Software Inc. This program allows the user to specify source and target directories and performs a synchronization operation between these specified directories every n seconds, where n is also specified by the user. The program also allows the user to specify what types of files to include and exclude from the synchronization and the type of synchronization (e.g. Bi-directional sync, Replicate Source to Target) to be performed. Assume that music files on the house computer are located at C:\Music and the vehicle stores the music files in Car:\Music. Furthermore, assume we want to perform a bi-directional synchronization between the MP3 files in C:\Music and Car:\Music while excluding the WAV files. Finally, we want to perform the synchronization every 5 seconds. The user can set the software as shown in FIG. 2. The program will attempt to locate the vehicle on the MWLAN every 5 seconds. If the vehicle is not in the vicinity of the house, the program will fail making a connection with the vehicle and attempt again in 5 seconds. When the vehicle approaches the house the program will succeed locating the vehicle and will access the files in the vehicle through the wireless LAN connection. Once the connection is accomplished the program will automatically perform the synchronization as indicated in the program. A diagram describing the operation of the software can be found in FIG. 3.

A consequence of this type of system is that, whenever new music files are added to the house system, they automatically become available on the vehicle's music system for instantaneous use. Play lists and other music play-control and information files, can be created at a fixed network node, specifically for transfer to, and use in, the music system of a vehicle. Similarly, any such files in the vehicle can then be transferred to and made available for use at a fixed node, such as a house.

Yet another application is the transmission and storage of an alternate audio file that would accompany a music file. In a vehicle environment, when a new musical piece, or selection, begins, the simple push of a button or a verbal command could pause the selection and provide verbal identifying information or other appropriate information that is keyed to the music file. The current state of the art in voice control for computer-related devices is well advanced and we can choose from many possible solutions for the simple type of voice control that our invention employs. Both software and hardware solutions are commonly available and are well known to those skilled in the art. Hence, they will not be described in detail. As an illustration, however, Home Automated Living, of Laurel, Md., provides extensive software for enabling voice activation through any microphone connected to a personal computer. They provide hardware and software products that enable users to control their home lights, devices, appliances, thermostat, home theater, security, etc., with normal conversational speech. They even provide the HAL Digital Music Center which can record CDs to a computer hard drive and categorize them by artist, song, album, genre, year, etc. One can then activate the system by a simple spoken command such as “Play the Beatles.”

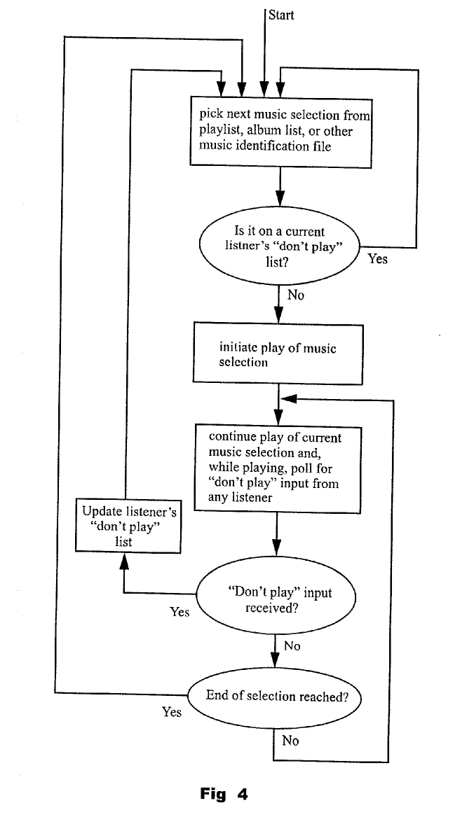

Such a system in a vehicle player, as illustrated by the flow chart of FIG. 4, would enable a particular listener to identify himself to the system by entering a pre-designated code number sequence on the preset buttons or by a verbal command, to instruct play criteria (i.e. a “don't play” or exclusion list), which enables the system to screen out any non-conforming selections, performers, or types of selections (e.g. “don't play Blue Suede Shoes”, or “don't play Johnny Cash pieces”, or “don't play classical music pieces”). The system can also recognize the simultaneous presence of identified multiple listeners to enable the player to omit any selection that any one, or more, of the listeners have included on their exclusion lists. Such exclusion lists can be compiled by having a listener so identify any selection while it is being played. Doing so will cause the selection to stop and the identifying information to be added to the listener's exclusion list. A similar capability can be provided for a house's music playing system and both the vehicle's and the house's don't play lists for all known listeners can be updated automatically each time the vehicle establishes a connection with the house's MWLAN.

An important feature of this invention is the system's high-bandwidth wireless communications capability. While numerous choices are available and well known to those skilled in the art, our preferred embodiment would employ an IEEE 802.11b communications system. A wireless communications system available from NDC Communications, Inc. of Sunnyvale, Calif., exhibits the properties we employ. In their SOHOware Series, they provide a Cablefree NetBlaster which connects to a PC through a standard network cable (Cat. 5 UTP Cable) and Cablefree wireless network interface cards which connect directly to desktop or laptop computers either in a motherboard slot or via a PCMCIA slot, respectively. A stationary node in our system could employ a PC component using the NetBlaster and a mobile node in our system could employ a computer system comprising components commonly found in a laptop computer, including a Cablefree wireless network interface card. The range of such a system has been determined to be at least 50 feet in a house-to-car environment.

Another feature of this invention is the system's configuration in a manner such that it operates autonomously in the performance of its tasks, without the need for specific commands from a human operator. For example, whenever new music files are stored on the house computer, they can be automatically transferred to the vehicle computer at the first available opportunity.

Similarly, each time the vehicle computer is moved and subsequently wirelessly reconnects to the house computer, vehicle diagnostic data, including voluminous amounts of raw data on the vehicle's mechanical operation, can be automatically transferred to the house computer. There, such data, including comparisons to vehicle system performance data previously stored at the house computer node, can be automatically processed to derive insights into the status of the vehicle's physical systems. This can result in the automatic preparation of a status report on the vehicle that can be displayed at the house and/or copied back to the vehicle. In this manner, the vehicle owner can be notified the next time the house computer is used, or can be automatically notified of any abnormality by the vehicle, should the user attempt to drive the vehicle. While simple data gathering and diagnostic capabilities can be, and have been, performed within the confines of a vehicle computer system, the system of this invention permits the convenient storage of more extensive measured data and more complex analyses of the data by algorithms that could avail themselves of vehicle manufacturer's information via an internet connection from the house. It also provides for the establishment of an automatic notification mechanism for a subsequent driver of the vehicle or user of the house computer, an action that takes place automatically and subsequent to the data communication action.

When the vehicle moves to another location, such as an office, it can become a part of another local area network where a fixed node in the office wirelessly interacts with the vehicle's system in a similar manner. Here again, files from the vehicle's system can be mirrored in the office node's system. Any files created or modified at the office, such as word processing files, spreadsheets, graphics, etc., can be automatically transmitted to the vehicle and, subsequently, when the vehicle is driven home, automatically transmitted to the house computer, and become immediately available for work at home. Although this data transfer from office to home is one that can be provided by modem communications, an advantage provided by this new form of “telecommuting” is that only simple short-range communications are required, thus eliminating on-going fee-based long-distance (i.e., internet) communications that are otherwise required. A significant advantage of this arrangement is the improved security when compared to using the internet, and the elimination of the necessity of using encryption, although it can still be used. An additional advantage is that the data are available, without specific advance planning, wherever the user travels in a vehicle equipped with this system. This provides unprecedented data availability even in remote locations where internet communications might be impractical. Also, a user can drive the vehicle to locations where no computer is available and use the vehicle's computer there.

In another embodiment of this invention, a laptop computer could also serve the function of a mobile node (i.e., as the “vehicle”), to automatically provide a means to keep the files of a house and an office computer in synchronization. However, since a laptop computer employs a much smaller battery than does a vehicle, it would seem to require the conscious action of (at least) turning the laptop computer on upon each arrival at the house and the office. Our system can provide an automatic file synchronization capability in this case, too, if the laptop computer is put into a low-power-consumption “sleep mode” rather than turned off during travel. Then, a very infrequent “node searching” action can be performed during sleep mode and it can automatically bring the computer out of sleep mode when another node is found. That is, it is as “automatic” as a vehicle-based mobile node.

An additional application for the MWLAN of this invention is the purchase of items required for vehicle operation. If a gas station is configured as a node in the network, then the purchase of fuel could entail merely conventionally parking the vehicle adjacent to the pump and pumping the fuel into the vehicle's tank. The interaction of the nodes would automatically charge the fuel purchase to a designated credit card or account. With the introduction of automatic pumping systems, the vehicle operator would not need to leave the vehicle. This would eliminate locating a credit card, inserting it into a slot, waiting for authorization, or communicating with the station attendants. In the many instances, when the automatic card reader at the pump is inoperative, this system eliminates the necessity of leaving the vehicle and entering the station to wait in line until the purchase can be consummated by either credit/debit card or cash.

Another use of this system is the purchase of oil and other necessary consumables that could similarly be ordered automatically. These purchases could be automatically initiated by the vehicle's diagnostic systems. Identification of parts sizes or service specifications (optimum tire pressure, for example) could be automatically transmitted to the station attendant. Mistakes made by station attendants, such as installation of incorrect parts, could automatically be brought to the vehicle operator's attention, provided that suitable diagnostic transducers are incorporated into the vehicle and appropriately interfaced to the vehicle's computer system.

Yet another application of the MWLAN of this invention is the facilitation of various personal services, such as picking up dry cleaning. If the dry cleaner has an appropriate node installed on its premises, the vehicle operator's intention to pick up a completed dry cleaning order could be signaled to the dry cleaner when the vehicle's node enters the range of the dry cleaner's node. Then the order could be made available for drive-through or counter pickup by the time the customer reaches the pickup counter, and the cost automatically charged, by the time the customer reaches the dry cleaner's store. Actual physical credit/debit card use is eliminated since the identification and authorization functions are initiated automatically by the initial MWLAN interconnection handshake. This system is also useful when a vehicle operator drops off clothing for cleaning, since the usual clothing-identification information could be entered into the vehicle's node for later transmission into the store's record-keeping system when the operator enters the store node's range. Thus, the order could be quickly dropped off in a drive-through without the need for waiting in line or interfacing with store personnel. Confirmation of receipt would automatically be transmitted to the vehicle before its departure, thus eliminating the usual paper receipt. A warning that no such confirming transmission has occurred could be given if the driver enters drop-off information into the vehicle's system and begins to leave prematurely. Alternatively, order and clothing receipt information could subsequently be transmitted from the dry cleaner to the house node via e-mail, telephone, etc., transmission, and subsequently automatically be transferred to the vehicle by the house computer. As a result of this information transmission, pickup date reminders could automatically be given to the driver in the vehicle.

If a record store is equipped as a node in the MWLAN system of this invention, music may be purchased by simply driving up to a downloading station and making the appropriate selections. The selections may be made without leaving the vehicle by establishing a network connection with the store's database of available music. Any customer, who does not wish to pay the price necessary to purchase a copy of the music file for an unlimited amount of time, can be provided with the option of leasing the files for use for a limited time period (e.g., a number of days) for a lesser amount. A self-destructing license file would accompany the music file to ensure erasure of the music file upon license expiration. The payment would automatically be processed through the identification and authorization of a credit/debit card transaction initiated by the initial MWLAN interconnection handshake. The store benefits in many ways, such as never running out of inventory, limiting the inventorying to only one copy of the file for copying, and reduction in store space and personnel required to operate.

In an application of the MWLAN system of this invention for a video rental/purchase store, modules capable of operating at high bit rates would be required. This results in shorter range, since, in this application, the transmitter and the receiver must be positioned very close to one another. Here, a customer need only drive to a downloading station to rent or purchase movies, eliminating the usual process of locating the desired movie in the store. More importantly, the necessity of returning rental items to the store is eliminated when a self-destructing license file is included with the rental transmission, as is the risk of being charged a late return fee. As with the music store, the movie rental store benefits from needing less space and fewer employees. It can never run out of its inventory, which never becomes worn out or damaged as is rental inventory. Another advantage is that the store owners could provide movie previews for the benefit of customers having vehicles equipped with a television. Also, passengers in such vehicles can view the movies when the vehicle is parked in the vicinity of an equipped house by establishing a wireless connection between the transceiver connected to the house VCR and the transceiver in the vehicle.

A similar system can be provided for purchase of software from a computer/software store.

Yet another application of this invention is its use as a vehicle-theft alarm. While a vehicle is parked in the vicinity of a house or office or some other location at which its mobile node can interact with a fixed node, the mobile node can sense when the vehicle is subjected to unauthorized movement and send a “Help! I'm moving!” alarm message to the fixed node. This can trigger an action, such as notifying the police and/or sounding of an alarm in the vicinity of the fixed node. In a similar manner, the unexpected, unauthorized interruption of the communication link between the mobile node and fixed nodes can initiate the alarm or police notification.

Similarly, the fixed node can sense an intrusion or emergency in the house and notify the mobile node, which then initiates the alarm message via a vehicle-based cell phone or other wireless means, or sounds a vehicle alarm.

If a laptop computer is the mobile node, the presence of the laptop in a hotel room, or other area having fixed node (e.g., 802.11) capabilities, could initiate the automatic interconnection of the laptop to the hotel's wireless LAN, so that the laptop owner would have instant access to the internet, to strategically placed hotel printers, and other similar equipment. Moreover, the disconnection of the laptop from the hotel's wireless LAN could automatically initiate a “checkout” routine by the hotel's accounting system, thereby causing the hotel guest's bill to be ready upon his/her arrival at the checkout counter. Such use of the MWLAN of this invention would be more efficient than using a modem and phone line and should offer higher performance at lower price.

In situations where the content of a data file (e.g., proprietary music selections) may only be used in one location (i.e., there is a single-site license), it would be convenient if the owner could have the music available wherever he/she is. This could be accomplished easily by having the vehicle and house systems organized such that each one requires the presence of a “license file” in order to play the licensed music files. The actual music files could be automatically copied and maintained on both systems as described previously. One of the systems could be designated as the “default license holder.” If the vehicle is designated, the user could play the licensed music in the vehicle. When arriving at the house, the license could be automatically transferred to the house for a fixed time period, or until such time that the wireless house-to-vehicle LAN connection is broken. Thus, the vehicle automatically again becomes the license holder when the vehicle leaves and breaks the LAN connection, and the vehicle operator regains access to all the music files. Several variations on this arrangement are possible. For example, if there is reason to keep the license at the house, even without the vehicle's proximity, then a simple command to the system could override this automatic disconnect resulting in a more permanent vehicle-to-house license transfer. Later, when the vehicle has departed, any desired transfer of the license between house and vehicle could be performed over a cell-phone, pager or other public wireless communications network. Music files could also be organized into various categories, e.g., Mom's Music, Dad's Music, Kids' Music, etc., each with its own license default/activation/transfer priorities. This could be organized to the level of individual selections, wherein, via cell phone connection, if necessary, all files would always be available for play at any location, except the specified selections that are currently playing at another location.

Another feature of this invention involves a vehicle clock. It is presently possible to have all computer clocks in a house's LAN synchronized via an internet connection on one of the house's computers. Typically, this guarantees accuracy of their time readout to within about ½ second. Therefore, each time the vehicle is connected to the house, via MWLAN, the vehicle's clock could be automatically set to the correct time, and it would end the semi-annual chore of resetting to accommodate Daylight Savings Time changes. It could also assure that, upon movement of the vehicle to a new time zone, connection to a fixed node there would automatically adjust the vehicle clock.

While it is known to use a mobile LAN to transfer information between a mobile and a fixed node, this invention goes a step further and provides a system which causes performance of useful functions, as exemplified above, which are extrinsic to the communication itself, even while the mobile node is disconnected from the other nodes. Specific functions or actions are automatically initiated by the connection and disconnection of a mobile node from the fixed node.

Although only a preferred embodiment has been described herein, many modifications will become readily apparent to one skilled in the art. For example, the vehicle housing the mobile node can be a bus, truck, airplane, boat, train or other conveyance, as well as a laptop computer or personal digital assistant. The fixed node can be located in a house or any other type of building. It is even envisioned that the “fixed” node could also be movable, and that the defined and limited area of communications could be relative.

What is claimed is:

1. A mobile wireless local area communications network comprising:
a pair of nodes, namely a first node and a second node, said first node is movable into and out of a limited area of communication capability relative to said second node, said first node being associated with a vehicle, and said first node automatically transmitting vehicle data over said communication to said second node.

2. The mobile wireless local area communications network of claim 1 wherein said vehicle data is diagnostic information about said vehicle.

3. The mobile wireless local area communications network of claim 1 wherein said vehicle data is abnormality information about said vehicle.

4. The mobile wireless local area communications network of claim 1 wherein said vehicle data is transferred to another system for performing analyses of said vehicle data.

5. The mobile wireless local area communications network of claim 1 wherein said vehicle data is an alarm message triggered in the event of unauthorized use.

6. The mobile wireless local area communications network of claim 1 wherein said vehicle data is an alarm message triggered in the event of theft.

7. The mobile wireless local area communications network of claim 6 wherein said vehicle data is further transmitted to the authorities.

8. The mobile wireless local area communications network of claim 1 wherein said vehicle data is payment data for gasoline.

9. The mobile wireless local area communications network of claim 1 wherein said vehicle data is order information for a vehicle part or vehicle service.

10. A mobile wireless local area communications network comprising:
three nodes, namely a first node, a second node, and a third node, said first node is movable into and out of a limited area of communication relative to said second node, said first node being associated with a vehicle, said first node being within an area of communication capability relative to said third node, said first node automatically transmitting alarm message over said communication to said third node when said communication between said first node and said second node ceases to function.

11. A method of transferring data between a pair of nodes, namely a first node and a second node, comprising the steps of:
establishing a limited geographical area of communications relative to said second node,
associating said first node with a vehicle,
moving said first node from outside of said limited geographical area of communications into said limited geographical area of communications, and
automatically transferring vehicle data between said first node and said second node.

12. The method of claim 11, wherein said vehicle data is diagnostic information about said vehicle.

13. The method of claim 11, wherein said vehicle data is abnormality information about said vehicle.

14. The method of claim 11, further comprising the step of transferring said vehicle data from said second node to another system for performing analyses of said vehicle data.

15. The method of claim 11 wherein said vehicle data is an alarm message triggered in the event of unauthorized use.

16. The method of claim 11 wherein said vehicle data is an alarm message triggered in the event of theft.

17. The method of claim 16 further comprising the step of transmitting said vehicle data to the police.

18. The method of claim 11 wherein said vehicle data is payment data for gasoline.

19. The method of claim 11 wherein said vehicle data is order information for vehicle parts.

20. A method of transferring data between three nodes, namely a first node, a second node, and a third node comprising the steps of:
establishing a limited geographical area of communications relative to said second node,
associating said first node with a vehicle,
moving said first node from outside of said limited geographical area of communications into said limited geographical area of communications, and
automatically transferring alarm message from said first node to said third node when said communication between said first node and said second node ceases to function.
